(19) United States
(12) Patent Application Publication
(10) Pub. No.: US 2019/0139528 A1
(43) Pub. Date: May 9, 2019

(54) COMPRESSOR AND SOUND INSULATING MEMBER FOR COMPRESSOR

(71) Applicant: LG ELECTRONICS INC., Seoul (KR)

(72) Inventors: Sangmin LEE, Seoul (KR); Jeehyun KIM, Seoul (KR); Sangeun BAE, Seoul (KR); Jihyun YOON, Seoul (KR); Jongwoo LEE, Seoul (KR)

(21) Appl. No.: 16/098,731

(22) PCT Filed: Apr. 27, 2017
(86) PCT No.: PCT/KR2017/004528

§ 371 Date: Nov. 2, 2018

(30) Foreign Application Priority Data
May 3, 2016 (KR) 10-2016-0054927

(51) Int. Cl. G10K 11/168; F04B 39/00; B32B 5/02; B32B 5/06; B32B 3/06; B32B 1/08; B32B 25/10

(52) U.S. Cl. CPC G10K 11/168; F04B 39/0033; B32B 5/022; B32B 5/06; B32B 3/06; B32B 2597/00; B32B 25/10; B32B 2250/02; B32B 2262/0253; B32B 2307/102; B32B 2307/3065; B32B 1/08

(57) ABSTRACT

The present invention relates to a compressor and a sound insulating member for a compressor, the compressor comprising: a cylindrical shell; a first shell cover and a second shell cover which cover both open ends of the shell; a plurality of legs extending from an outer surface of the shell and fixed to an installation space; a suction pipe connected to the first shell cover and through which a refrigerant flows; a terminal provided on an outer circumferential surface of the shell and connected to a power supply terminal; a process pipe connected to an outer circumferential surface of the shell for replenishing the refrigerant; and a sound insulating member provided with a discharge pipe, which is connected to an outer circumferential surface of the shell and through which the compressed refrigerant is discharged, and a coupling part which is formed in a sheet shape closely contacting the outer circumferential surface of the shell to block vibration noises of the shell and has both ends coming into contact so as to be bound to each other.

### TECHNICAL FIELD

The present invention relates to a compressor and a sound insulating member for a compressor.

### BACKGROUND ART

A cooling system, which is a system that produces cold air by circulating a refrigerant, repeats compression, condensation, expansion, and evaporation of a refrigerant. To this end, the cooling system includes a compressor, a condenser, an expansion device, and an evaporator. The cooling system may be installed in a refrigerator or an air conditioner as an appliance.

In general, a compressor, which is a mechanical apparatus that increases the pressure of air, a refrigerant, or other various working gases by compressing them using power from a power generator such as an electric motor or a turbine, is generally used for appliances or throughout industry.

The compressor can be largely classified into a reciprocating compressor in which a compression space, to or from which a working gas is suctioned or discharged, is defined between a piston and a cylinder and the piston compresses a refrigerant by reciprocating straight in the cylinder, a rotary compressor in which a compression space, to or from which a working gas is suctioned or discharged, is defined between a cylinder and an eccentrically rotating roller, and the roller compresses a refrigerant by eccentrically rotating along the inner wall of the cylinder, and a scroll compressor in which a compression space, to or from which a working gas is suctioned or discharged, is defined between an orbiting scroll and a fixed scroll and the orbiting scroll compresses a refrigerant by rotating along the fixed scroll.

Recently, a linear compressor that can improve compression efficiency with a simple structure without a mechanical loss due to conversion of motions by having a piston directly connected to a driving motor that generates a straight reciprocating motion has been developed as one of the reciprocating compressors.

Further, development for reduce the size and noise of compressor have been conducted.

A structure that includes side sound insulating member and a top sound insulating member are combined to accommodate a compressor and can insulate sound that is generated by operation of the compressor to the outside to reduce noise of the compressor has been disclosed in Korean Patent Application Publication No. 10-2003-0055050.

However, according to this structure, a compressor and refrigerant pipes connected to the compressor are all accommodated in the space defined by the side sound insulating members and the top sound insulating member, so the volume of the structure for preventing noise is increased. Accordingly, a large installation space is required and the volume of a refrigerator or an outdoor unit of an air conditioner that includes a compressor is increased. In particular, such an increase in volume of a refrigerator may reduce the capacity.

### DISCLOSURE

### Technical Problem

An object of the present invention is to provide a compressor and a sound insulating member for a compressor that can reduce noise while minimizing an increase in volume by surrounding a cylindrical compressor shell.

Another object of the present invention is to provide a sound insulating member for a compressor that can be easily mounted on a cylindrical compressor shell.

Another object of the present invention is to provide a compressor having a structure that allows a sound insulating member surrounding a cylindrical compressor shell to be easily mounted.

Another object of the present invention is to provide a sound insulating member for a compressor that can effectively block noise by being in close contact with a cylindrical compressor shell.

### Technical Solution

A compressor according to an embodiment of the present invention includes: a cylindrical shell; a first shell cover and a second shell cover covering both open ends of the shell; a plurality of legs extending from the outer side of the shell to be fixed in an installation space; a suction pipe connected to the shell cover to suction a refrigerant; a terminal disposed on a circumferential surface of the shell and connected to a power supply terminal; a process pipe connected to the circumferential surface of the shell to supplement the refrigerant; a discharge pipe connected to the circumferential surface of the shell to discharge compressed refrigerant; and a sound insulating member formed in a sheet shape to be in close contact with the circumferential surface of the shell, blocking vibration noise of the shell, and having fastening portions formed at both ends to be fastened to each other.

The sound insulating member includes: a first layer formed in the type of felt of non-woven fabric and being in close contact with the outer side of the shell to absorb vibration noise; and a second layer forming a surface exposed outside by being bonded to the first layer and made of an elastic member to press the outer side of the shell.

A side of the sound insulating member that corresponds to the positions of the legs, the terminal, the process pipe, and the discharge pipe is open.

The terminal, the process pipe, and the discharge pipe are disposed close to the second shell cover at the center of the shell.

The terminal, the process pipe, and the discharge pipe are positioned at different heights.

The terminal, the process pipe, and the discharge pipe are positioned within 90° around the axial center of the shell.

A sound insulating member for a compressor according to an embodiment of the present invention includes: a first layer formed in the type of felt of non-woven fabric and being in close contact with the outer side of the shell, which forms the circumference of a cylindrical compressor, to absorb vibration noise; and a second layer forming a surface exposed outside by being bonded to the first layer and made of an elastic member to press the outer side of the shell, in which fastening portions fastened to each other with the second layer extended are formed at both ends of the second layer.

The first layer is made of an inflammable polyethylene material.

An edge portion is defined by stitching a thread or a wire around the first layer and the second layer to combine the first layer and the second layer.

The fastening portions include a first fastening portion and a second fastening portion formed in a male/female Velcro structure respectively at both ends of the second layer.

A sound insulating member for a compressor according to an embodiment of the present invention includes: a rectangular sheet made of a sound absorbing material and having a width corresponding to a cylindrical compressor shell and a length corresponding to the circumference of the shell; fastening portions formed at both longitudinal ends of the sheet and fastened to each other while surrounding the shell; first cut portions formed at both width-directional ends of the sheet and exposing legs for fixing the shell; and an opening formed at a position corresponding to a terminal, a process pipe, and a discharge pipe connected to the shell to expose the terminal, the process pipe, and the discharge pipe.

The opening is a second cut portion formed at a width-directional end of the sheet close to the first cut portion to pass the terminal, the process pipe, and the discharge pipe.

The second cut portion includes: a terminal portion formed to be open in a shape corresponding to the terminal; and a pipe portion cut at a width-directional end of the sheet to connect the terminal portion and passing both of the process pipe and the discharge pipe.

The width of the pipe portion is larger than the distance between outer side ends of the process pipe and the discharge pipe.

The opening includes: a terminal hole formed at a position corresponding to the terminal to pass the terminal; a first pipe hole formed at a position corresponding to the joint between the process pipe and the shell to pass the process pipe; and a second pipe hole formed at a position corresponding to the joint between the discharge pipe and the shell to pass the discharge pipe.

A third cut portion cut from a width-directional end of the sheet to at least any one of the first pipe hole or the second pipe hole is further formed at the sheet.

### Advantageous Effects

The following effects can be expected from the compressor and the sound insulating member for a compressor according to an embodiment of the present invention.

According to an embodiment, the insulating member has a structure that is completely in close contact with the circumferential surface of the shell of the compressor by the elastic second layer and fastening portions, so an increase in volume of the compressor can be minimized even with the sound insulating member applied.

Further, since the entire shell of the compressor is covered with the sound insulating member, an effect that remarkably blocks vibration and noise generated from the shell having a cylindrical structure can be expected. Further, a specific structure for preventing noise in the compressor can be removed due to operation of the sound insulating member, so it is possible to reduce the manufacturing cost and improve productivity.

Further, since it is possible to reduce noise by mounting the sound insulating member on the outer side of the shell of the compressor, there is no need for a separate configuration for reducing noise in the shell, so the size of the compressor can be reduced.

Further, by mounting the sound insulating member on the outer side of the shell, it is possible to effectively reduce noise of the small-sized compressor without a noise reduction structure therein.

Further, it is possible to expose the terminal, the process pipe, and the discharge pipe disposed on the outer side of the shell only by covering the shell with the sound insulating member with the sound insulating member having a sheet shape placed with the first cut portions at the legs of the shell, so the sound insulating member can be simply mounted.

Further, since the terminal, the process pipe, and the discharge pipe disposed outside the compressor are all positioned in an area close to a side of the circumferential surface of the shell, they can pass at one time the mounting member when the mounting member is mounted. Further, they can be more easily connected to a terminal or other pipes later.

### DESCRIPTION OF DRAWINGS

FIG. 1 is a perspective view of a compressor before a sound insulating member according to an embodiment of the present invention is mounted.

FIG. 2 is a side view of the compressor before the sound insulating member is mounted.

FIG. 3 is an exploded perspective view of a shell and a shell cover of the compressor.

FIG. 4 is an exploded perspective view of inner parts of the compressor.

FIG. 5 is a cross-sectional view taken along line I-I′ of FIG. 1.

FIG. 6 is a plan view of the sound insulating member.

FIG. 7 is a cross-sectional view taken along line II-II′ of FIG. 6.

FIG. 8 is a perspective view showing the compressor equipped with the sound insulating member from a side.

FIG. 9 is a perspective view showing the compressor equipped with the sound insulating member from another side.

FIGS. 10 to 12 are views sequentially showing a process of mounting the sound insulating member.

FIG. 13 is a plan view of a sound insulating member according to another embodiment of the present invention.

### MODE FOR INVENTION

Hereinafter, detailed embodiments of the present invention are described with reference to drawings. However, the spirit of the present invention is not limited to the embodiments proposed herein and those skilled in the art who understand the spirit of the present invention would easily propose other embodiments within the same range of the spirit.

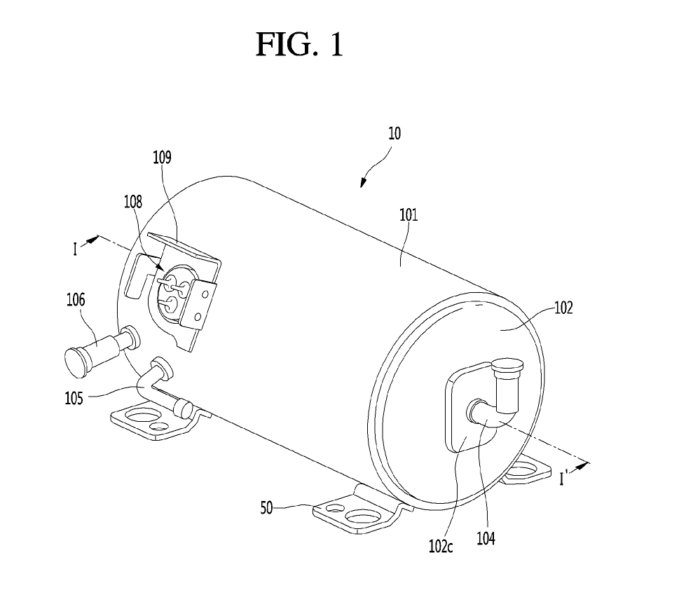

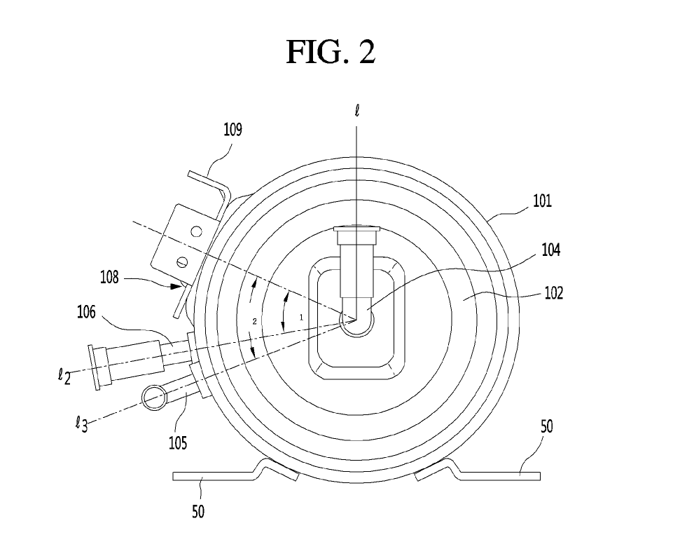

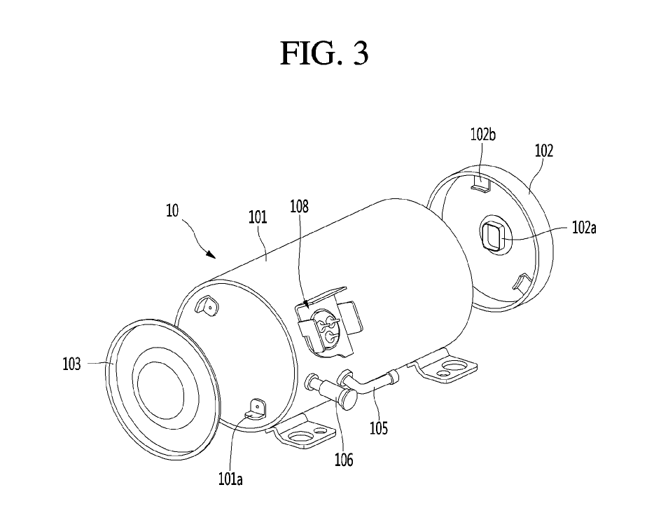

FIG. 1 is a perspective view of a compressor before a sound insulating member according to an embodiment of the present invention is mounted. FIG. 2 is a side view of the compressor before the sound insulating member is mounted. FIG. 3 is an exploded perspective view of a shell and a shell cover of the compressor.

Referring to FIGS. 1 and 3, a compressor 10 according to an embodiment of the present invention includes a shell 101 and shell covers 102 and 103 combined with the shell 101. In a broad meaning, the first shell cover 102 and the second shell cover 103 can be understood as components of the shell 101.

Legs 50 may be coupled to the bottom of the shell 101. The legs 50 may be coupled to the base of a product on which the compressor 10 is installed. For example, the product may include and the base may include the base of the mechanical chamber of the refrigerator. Alternatively, the product may include the outdoor unit of an air conditioner and the base may include the base of the outdoor unit.

The shell 101 may have a substantially cylindrical shape and may be laid down laterally or axially. On the basis of FIG. 1, the shell 101 may be laterally elongated and may have a relatively small radial height. That is, the compressor 10 may be small in height, so when the compressor 10 is disposed on the base of the mechanical chamber of a refrigerator, the height of the mechanical chamber can be reduced.

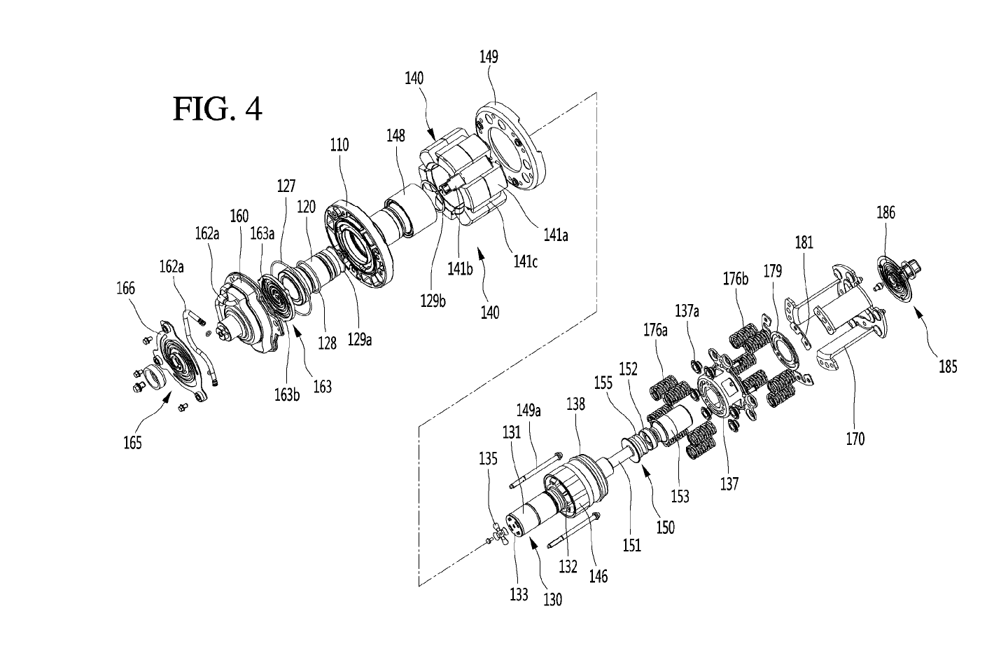

A terminal 108 may be disposed on the outer side of the shell 101. The terminal 108 is understood as a component that transmits external power to a motor assembly 140 (see FIG. 4) of the linear compressor. The terminal 108 can be connected to a lead wire of a coil 141c (see FIG. 4).

A bracket 109 is disposed outside the terminal 108. The bracket 109 may include a plurality of brackets disposed around the terminal 108. The bracket 109 may perform a function of protecting the terminal 108 from external shock etc.

Both sides of the shell 101 are open. The shell covers 102 and 103 can be coupled to both open sides of the shell 101. In detail, the shell covers 102 and 103 include a first shell cover 102 coupled to one open side of the shell 101 and a second shell cover 103 coupled to the other open side of the shell 101. The internal space of the shell 101 can be sealed by the shell covers 102 and 103.

In FIG. 1, the first shell cover 102 may be positioned at the right side of the compressor 10 and the second shell cover 103 may be positioned at the right side of the compressor 10. In other words, the first and second shell cover 102 and 103 may be arranged opposite each other.

The first shell cover 102 and the second shell cover 103 may be formed thicker than the shell 101 and may be given sufficient strength to be able to prevent noise and vibration.

The first shell cover 102 and the second shell cover 103 may be formed by foaming. The first shell cover 102 may protrude outward to be able to secure a deformation space by elasticity of a second support spring 186 to be described below. Further, the first shell cover 102 may be generally rounded to prevent damage or deformation by pressure. The edge of the first shell cover 102 may be bent in surface contact with the inner side of the shell 101 and the edge and the inner side may be combined by welding.

The second shell cover 103 may be formed by foaming in a recessed shape to be disposed inside the shell 101 and the other portion except for the edge of the second shell cover 103 may be disposed inside a the open end of the shell 101. The center of the second shell cover 103 may protrude outward, thereby providing a deformation space by elasticity of the first support spring 166. The edge of the second shell cover 103 may also be bent in surface contact with the inner side of the shell 101 and the edge and the inner side may be combined by welding.

Both sides of the compressor 10 can be formed by foaming the first shell cover 102 and the second shell cover 103.

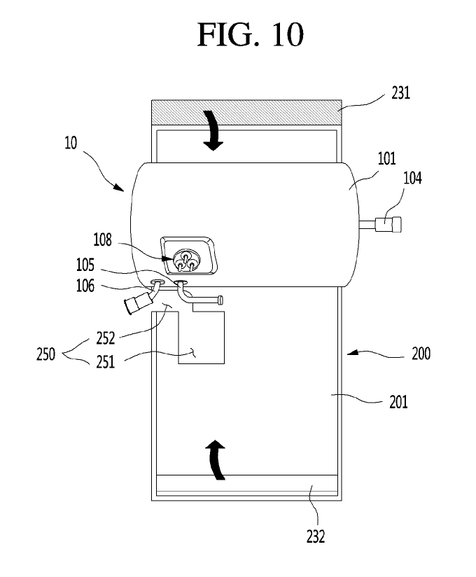

On the other hand, the shell 101 may be formed relatively thinner, and even if it is given the same thickness as the first shell cover 102 and the second shell cover 103, it is unavoidably vulnerable to vibration due to the structural characteristic of the long cylindrical shape, so vibration and noise due to the characteristic may be transmitted to the outside. Accordingly, a sound insulating member 200 (see FIG. 8) for preventing the vibration and noise from being transmitted to the outside is disposed around the shell 101.

The compressor 10 further includes a plurality of pipes 104, 105, and 106 disposed at the shell 101 or the shell covers 102 and 103 to suction, discharge, or inject a refrigerant.

The pipes 104, 105, and 106 include a suction pipe 104 for suctioning a refrigerant into the compressor 10, a discharge pipe 105 for discharging a compressed refrigerant out of the compressor 10, and a process pipe 106 for supplementing the compressor 10 with a refrigerant.

For example, the suction pipe 104 may be coupled to the first shell cover 102. A refrigerant can be suctioned into the compressor 10 axially through the suction pipe 104.

The suction pipe 104 is disposed at the center of the first shell cover 102 and has a shape protruding outward. The suction pipe 104 has a shape bending upward outside the first shell cover 102. Accordingly, when a refrigerant pipe is connected to the suction pipe 104 with the compressor 10 installed, a work space is secured upward, so working become easy and the installation space for the entire compressor 10 can be minimized.

The discharge pipe 105 may be coupled to the outer side of the shell 101. The refrigerant suctioned through the suction pipe 104 can be compressed while axially flowing. The compressed refrigerant can be discharged through the discharge pipe 105. The discharge pipe 105 may be positioned closer to the second shell cover 103 than the first shell cover 102.

The process pipe 106 may be coupled to the outer side of the shell 101. A worker can inject a refrigerant into the compressor 10 through the process pipe 106.

The processor pipe 106 may be coupled to the shell 101 at a different height from the discharge pipe 105 to avoid interference with the discharge pipe 105. The height is understood as a vertical (or radial) distance from the legs 50. Since the discharge pipe 105 and the process pipe 106 are coupled at different heights to the outer side of the shell 101, a worker can conveniently work. The discharge pipe 105 may be positioned higher than the process pipe 106 and the discharge pipe 105 is bent for easy connection with the refrigerant pipe, and accordingly, the installation space of the compressor 10 can be minimized.

In detail, the terminal 108, the process pipe 106, and the discharge pipe 105 are disposed on the outer side of the shell 101 and are all positioned at a side of both sides from a radial extension line 1 passing through the center of the shell 101. Further, they all may be positioned close to the second shell cover 103 with respect to the middle portion of the shell 101.

With respect to the center of the shell 10, a virtual extension line l₁ going to the terminal 108 and a virtual extension line l₂ going to the process pipe 106 have a first set angle θ₁. With respect to the center of the shell 101, a virtual extension line l₁ extending toward the terminal 108 and a virtual extension line l₃ extending toward the discharge pipe 105 have a second set angle θ₂. The first set angle θ₁ is set larger than the second set angle θ₂ such that the terminal 108, the process pipe 106, and the discharge pipe 105 can be arranged at different angles around the shell 101. The terminal 108, the process pipe 106, and the discharge pipe 105 may be disposed within a range of about 90° so that work can be simultaneously performed at adjacent positions.

The arrangement of the terminal 108, the process pipe 106, and the discharge pipe 105 is provide to easily install the compressor 10, thereby preventing interference when a terminal is connected to the terminal 108 or the process pipe 106 and the discharge pipe 105 are connected to each other.

Further, when a sound insulating member 200 to be described below is mounted, an outwardly protruding portion of the sound insulating member 200 can be disposed in a predetermined area on the shell 101, whereby the sound insulating member 200 can be more easily mounted.

At least a portion of the second shell cover 103 may be positioned on the inner side of the shell 101, close to the position where the process pipe 106 is coupled. In other words, at least a portion of the second shell cover 103 can act as resistance against the refrigerant injected through the process pipe 106.

Accordingly, in terms of a channel for a refrigerant, a channel for a refrigerant that flows inside through the process pipe 106 is formed such that the size decreases toward the inside of the shell 101. While a refrigerant flows through the channel, it may evaporate due to a drop of pressure, and in this process, oil contained in the refrigerant can be separated. Accordingly, a refrigerant with oil removed flows into a piston 130, so the performance of compressing a refrigerant can be improved. The oil may be understood as a working oil existing in a cooling system.

A cover supporting portion 102a is formed on the inner side of the first shell cover 102. A second retainer 185 to be described below may be coupled to the cover supporting portion 102a. A shell protrusion 102C, which protrudes such that a space where the portion coupled to the second retainer 185 can move can be provided, may be formed at the center of the first shell cover 102. The shell protrusion 102C may be formed in a rectangular shape slightly larger tan the cover supporting portion 102a so that the cover supporting portion 102a can be accommodated.

The cover supporting portion 102a and the second retainer 102a may be understood as parts that support the body of the compressor 10. The body of the compressor means a part that is disposed in the shell 101, and for example, a driving assembly that reciprocates forward and backward and a supporting assembly that supports the driving assembly may be included in the body. The driving assembly may include a piston 130, a magnet frame 138, a permanent magnet 146, a supporter 137, and a suction muffler 150. The supporting assembly may include resonance springs 176a and 176b, a rear cover 170, a stator cover 149, a first retainer 165, and a first retainer 165.

Stoppers 102b may be formed on the inner side of the first shell cover 102. The stoppers 102b are understood as parts that prevent the body of the compressor 100, particularly, the motor assembly 140 from being damaged by hitting against the shell 101 due to vibration or shock that is generated while the compressor 10 is carried. The stoppers 102b are positioned close to the rear cover 170 to be described below, so when the compressor 10 is shaken, the rear cover 170 is held by the stoppers 102b, thereby being able to prevent shock from being transmitted to the motor assembly 140.

Spring couplers 101a may be formed on the inner side of the shell 101. For example, the spring couplers 101a may be positioned close to the second shell cover 103. The spring couplers 101a may be coupled to a first support spring 166 of the first retainer 165. Since the spring couplers 101a and the first retainer 165 are coupled to each other, the body of the compressor can be stably supported in the shell 101.

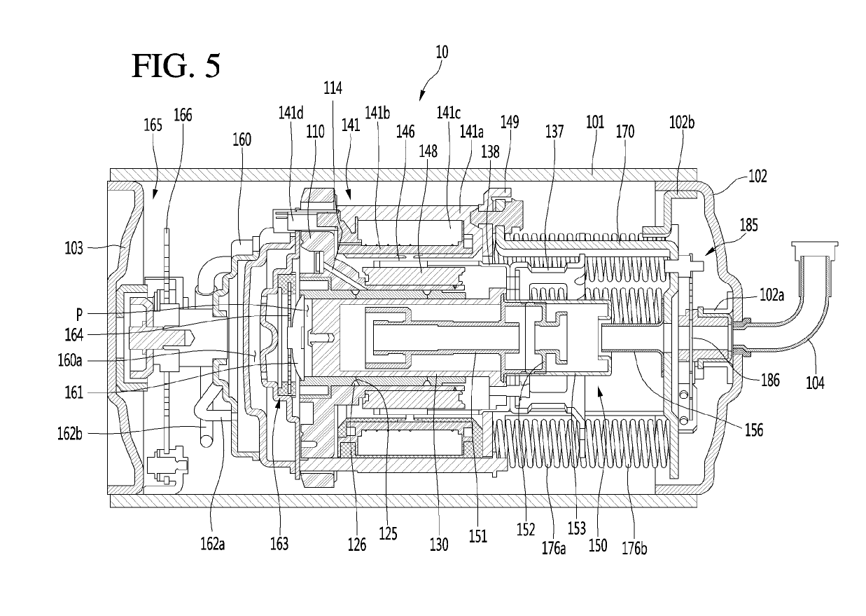

FIG. 4 is an exploded perspective view of inner parts of the compressor. FIG. 5 is a cross-sectional view taken along line I-I′ of FIG. 1.

Referring to FIGS. 4 and 5, the compressor 10 according to an embodiment of the present invention includes the cylinder 120 disposed in the shell 101, the piston 130 reciprocating straight in the cylinder 120, and the motor assembly 140 that is a linear motor providing a driving force to the piston 130. When the motor assembly 140 is operated, the piston 130 can be axially reciprocated.

The compressor 10 further includes a suction muffler 150 combined with the piston 130 to reduce noise that is generated by the refrigerant suctioned through the suction pipe 140. The refrigerant suctioned through the suction pipe 104 flows into the piston 130 through the suction muffler 150. The flow noise of the refrigerant can be reduced while the refrigerant flows through the suction muffler 150.

The suction muffler 150 includes a plurality of mufflers 151, 152, and 153. The mufflers 151, 152, and 153 include a first muffler 151, a second muffler 152, and a third muffler 153 that are assembled together.

The first muffler 151 is disposed in the piston 130 and the second muffler 152 is coupled to the rear end of the first muffler 151. The third muffler 153 accommodates the second muffler 152 and may extend rearward from the first muffler 151. In terms of the flow direction of the refrigerant, the refrigerant suctioned through the suction pipe 104 can sequentially flow through the third muffler 153, the second muffler 152, and the first muffler 151. The flow noise of the refrigerant can be reduced in this process.

The suction muffler 150 further includes a muffler filter 153. The muffler filter 153 may be disposed at the interface between the first muffler 151 and the second muffler 152. For example, the muffler filter 153 may have a circular shape and the outer side of the muffler filter 153 can be supported between the first and second mufflers 151 and 152.

Directions are defined.

The term “axial direction” may be understood as the reciprocation direction of the piston 130, that is, the transverse direction in FIG. 4. In the “axial direction”, the direction going toward a compression space P from the suction pipe 104, that is, the flow direction of a refrigerant is defined as a “forward direction” and the opposite direction is defined as a “rear direction” When the piston 130 is moved forward, the compression space P can be compressed.

On the other hand, a “radial direction” is a direction perpendicular to the reciprocation direction of the piston 130 and can be understood as a longitudinal direction in FIG. 4.

The piston 130 includes a substantially cylindrical piston body 131 and a piston flange 132 radially extending from the piston body 131. The piston body 131 can reciprocate in the cylinder 120 and the piston flange 132 can reciprocate outside the cylinder 120.

At least a portion of the first muffler 151 and at least a portion of the piston body 131 are accommodated in the cylinder 130.

The compression space P in which a refrigerant is compressed by the piston 130 is defined in the cylinder 120. Suction holes 133 allowing for a refrigerant to flow into the compression space P are formed at the front of the piston body 131 and a suction valve 135 for selectively opening the suction holes 133 is disposed ahead of the suction holes 133. Fastening holes in which predetermined fasteners are coupled are formed substantially at the center of the suction valve 135.

A discharge cover 160 defining a discharge space 160a for the refrigerant discharged from the compression space P and a discharge valve assembly 161 and 163 coupled to the discharge cover 160 to selectively discharge the refrigerant compressed in the compression space P are disposed ahead of the compression space P. The discharge space 160a includes a plurality of sections divided by the inner side of the discharge cover 160. The sections are arranged in the front-rear direction and can communicate with one another.

The discharge valve assembly 161 and 163 includes a discharge valve 161 that allows a refrigerant to flow into the discharge space of the discharge cover 160 by opening when the pressure in the compression space P becomes a discharge pressure or more and a spring assembly 163 that is disposed between the discharge valve 161 and the discharge cover 160 and axially provides elasticity.

The spring assembly 163 includes a valve spring 163a and a spring supporting portion 163b for supporting the valve spring 163a to the discharge cover 160. For example, a plate spring may be included in the valve spring 163a. The spring supporting portion 163b may be integrally formed with the valve spring 163a by injection molding.

The discharge valve 161 is coupled to the valve spring 163a and the rear portion or the rear surface of the discharge valve 161 is disposed to be able to be supported on the front surface of the cylinder 120. When the discharge valve 161 is supported on the front surface of the cylinder 120, the compression space P is maintained in a sealed state, and when the discharge valve 161 is spaced from the front surface of the cylinder 120, the compression space P is opened and the compressed refrigerant in the compression space P can be discharged.

Accordingly, the compression space P is understood as a space defined between the suction valve 135 and the discharge valve 161. The suction valve 135 may be formed at a side of the compression space P and the discharge valve 161 may be disposed at the other side of the compression space P, that is, opposite the suction valve 135.

When the pressure in the compression space P decreases to a suction pressure or less and is lower than a discharge pressure while the piston 130 reciprocates in the cylinder 120, the suction valve 135 is opened and a refrigerant is suctioned into the compression space P. However, when the pressure in the compression space P increases to the suction pressure or more, the refrigerant in the compression space P is compressed with the suction valve 135 closed.

When the pressure in the compression space P increases to the discharge pressure or more, the valve spring 163a opens the discharge valve 161 by deforming forward and a refrigerant is discharged from the compression space P into the discharge space of the discharge cover 160. When the refrigerant finishes being discharged, the valve spring 163a provides a restoring force to the discharge valve 161, so the discharge valve 161 is closed.

The compressor 10 further includes a cover pipe 162a coupled to the discharge cover 160 to discharge the refrigerant flowing through the discharge space 160a of the discharge cover 160. For example, the cover pipe 162 may be made of metal.

The compressor 10 further includes a loop pipe 162b coupled to the cover pipe 162a to transmit the refrigerant flowing through the cover pipe 162a to the discharge pipe 105. The loop pipe 612b may be coupled to the cover pipe 162a at a side and to the discharge pipe 105 at the other side.

The loop pipe 162b is made of a flexible material and may have a relatively large length. The loop pipe 162b may be rounded along the inner side of the shell 101 from the cover pipe 162a and coupled to the discharge pipe 105. For example, the loop pipe 162b may be wound.

The compressor 10 further includes a frame 110. The frame 110 is understood as a component for fixing the cylinder 120. For example, the cylinder 120 may be forcibly fitted in the frame 110. The cylinder 120 and the frame 110 may be made of aluminum or an aluminum alloy.

The frame 110 is disposed around the cylinder 120. That is, the cylinder 120 may be disposed inside the frame 110. The discharge cover 160 may be coupled to the front surface of the frame 110 by fasteners.

The motor assembly 140 includes an outer stator 141 fixed to the frame 110 around the cylinder 120, an inner stator 148 spaced apart inward from the outer stator 141, and a permanent magnet 146 disposed in the space between the outer stator 141 and the inner stator 148.

The permanent magnet 146 can be reciprocated straight by a mutual electromagnetic force with the outer stator 141 and the inner stator 148. The permanent magnet 146 may be a single magnet having one polarity or may be formed by combining a plurality of magnets having three polarities.

The permanent magnet 146 may be disposed on a magnet frame 138. The magnet frame 138 may have a substantially cylindrical shape and may be inserted in the space between the outer stator 141 and the inner stator 148.

In detail, on the basis of the cross-sectional view of FIG. 5, the magnet frame 138 may be combined with the piston flange 132, may extend radially outward, and may bend forward. The permanent magnet 146 may be disposed ahead of the magnet frame 138. When the permanent magnet 146 reciprocates, the piston 130 can axially reciprocate with the permanent magnet 146.

The outer stator 141 includes a coil assembly 141b, 141c, and 141d and a stator core 141a. The coil assembly 141b, 141c, and 141d includes a bobbin 141b and a coil 141c circumferentially wound around the bobbin. The coil assembly 141b, 141c, and 141d further includes a terminal 141d leading or exposing a power line connected to the coil 141c to the outside of the outer stator 141.

The stator core 141a includes a plurality of core blocks formed by circumferentially stacking a plurality of laminations. The core blocks may be arranged around at least a portion of the coil assembly 141b and 141c.

A stator cover 149 is provided at a side of the outer stator 141. That is, in the outer stator 141, a side may be supported by the frame 110 and the other side may be supported by the stator cover 149.

The compressor 10 further includes cover fasteners 149a for fastening the stator cover 149 and the frame 110. The cover fasteners 149a may extend forward toward the frame 110 through the stator cover 149 and may be coupled to the frame 110.

The inner stator 148 is fixed to the outer side of the frame 110. The inner stator 148 is formed by circumferentially stacking a plurality of o laminations outside the frame 110.

The compressor 10 further includes a supporter 137 that supports the piston 130. The supporter 137 is coupled to the rear of the piston 130 and the muffler 150 may be disposed through the supporter 137. The piston flange 132, the magnet frame 138, and the supporter 137 may be fastened to each other by fasteners.

A balance weight 179 may be coupled to the supporter 137. The weight of the balance weight 179 may be determined on the basis of the range of the operation frequency of the compressor body.

The compressor 10 further includes a rear cover 170 coupled to the stator cover 149, extending rearward, and supported by the first retainer 165.

In detail, the rear cover 170 has three supporting legs and the three supporting legs may be coupled to the rear surface of the stator cover 149. A spacer 181 may be disposed between the tree supporting legs and the rear surface of the stator cover 149. It is possible to determine the distance from the stator cover 149 to the rear end of the rear cover 170 by adjusting the thickness of the spacer 181. The rear cover 170 may be supported by the supporter 137.

The compressor 10 further includes an intake guide 156 coupled to the rear cover 170 to guide a refrigerant into the muffler 150. The intake guide 156 may be at least partially inserted in the suction muffler 150.

The compressor 10 further includes a plurality of resonance springs 176a and 176b of which the natural frequencies are adjusted such that the piston 130 can be resonated.

The resonance springs 176a and 176b include first resonance springs 176a supported between the supporter 137 and the stator cover 149 and second resonance springs 176b supported between the supporter 137 and the rear cover 170. By operation of the resonance springs 176a and 176b, the driving assembly that reciprocates in the compressor 10 can be stably operated and vibration or noise due to movement of the driving assembly can be reduced.

The supporter 137 includes first spring holders 137a coupled to the first resonance springs 176a.

The compressor 10 further includes a plurality of seals 127, 128, 129a, and 129b for more firmly combining the frame 110 and the components around the frame 110. In detail, the seals 127, 128, 129a, and 129b include a first seal 127 disposed at the joint between the frame 110 and the discharge cover 160.

In detail, the seals 127, 128, 129a, and 129b include a second seal 128 disposed at the joint between the frame 110 and the cylinder 120.

In detail, the seals 127, 128, 129a, and 129b include a third seal 129a disposed between the cylinder 120 and the frame 110. The third seal 129a can prevent a refrigerant in a gas pocket formed between the inner side of the frame and the outer side of the cylinder from leaking to the outside and can more firmly combining the frame 110 and the cylinder 120.

In detail, the seals 127, 128, 129a, and 129b include a fourth seal 129b disposed at the joint between the frame 110 and the inner stator 148.

The first to fourth seals 127, 128, 129a, and 129b each may have a ring shape.

The compressor 10 further includes a first retainer 165 coupled to the discharge cover 160 and supporting a side of the body of the compressor 10. The first retainer 165 is disposed close to the second shell 103 and can elastically support the body of the compressor 10. In detail, the first retainer 165 includes a first supporting spring 166. The first supporting spring 166 may be coupled to the spring couplers 101a.

The compressor 10 further includes a second retainer 185 coupled to the rear cover 170 and supporting the other side of the body of the compressor 10. The second retainer 185 is coupled to the first shell cover 102 and can elastically support the body of the compressor 10. In detail the second retainer 185 includes a second supporting spring 186. The first supporting spring 186 may be coupled to the cover supporting portion 102a.

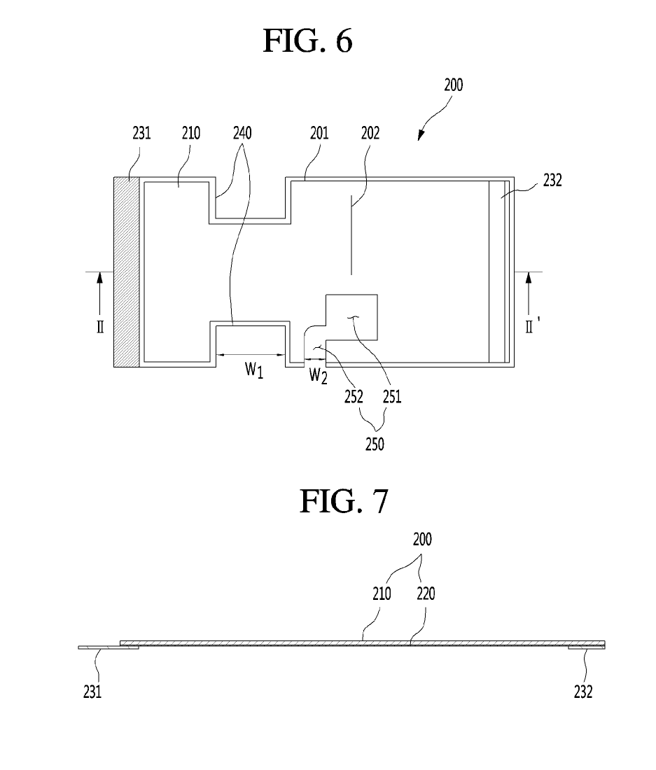

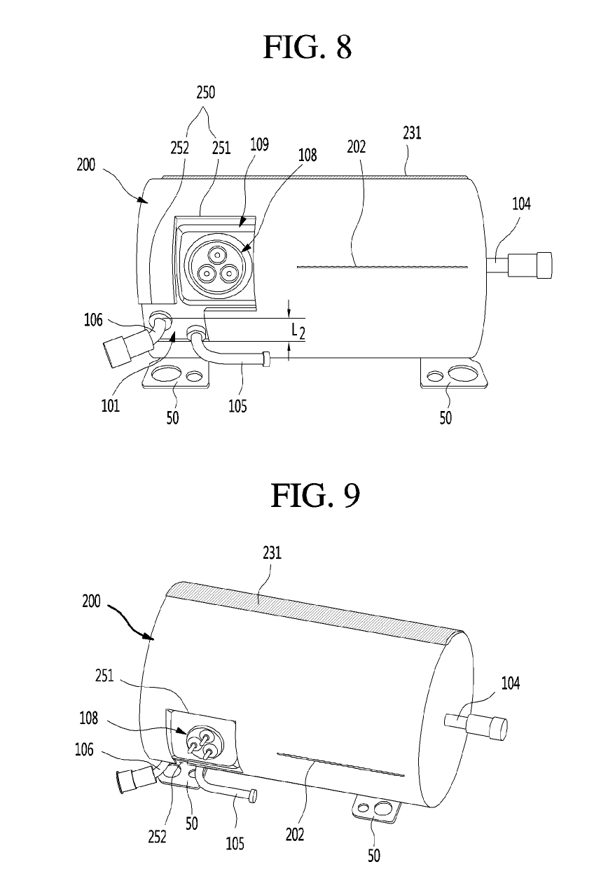

FIG. 6 is a plan view of the sound insulating member. FIG. 7 is a cross-sectional view taken along line II-II′ of FIG. 6. FIG. 8 is a perspective view showing the compressor equipped with the sound insulating member from a side. FIG. 8 is a perspective view showing the compressor equipped with the sound insulating member from another side.

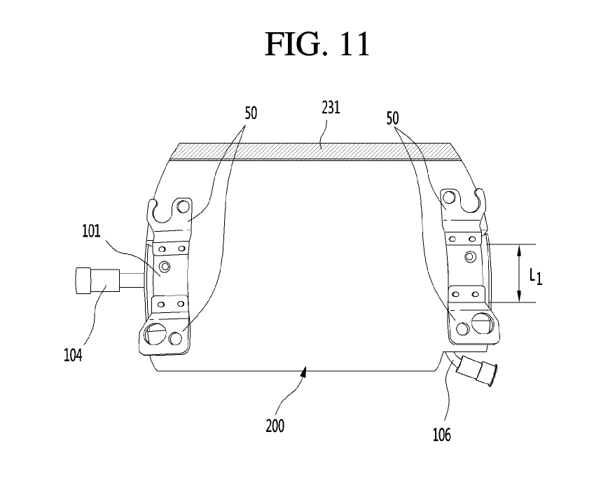

Referring to FIGS. 6 to 9, a sound insulating member 200 according to an embodiment of the present invention may be formed to surround the shell 101 formed in a cylindrical shape.

That is, the sound insulating member 200, as shown in FIG. 6, may be formed entirely in a rectangular sheet shape and may have a length corresponding to the axial length of the shell 101 and a width corresponding to or slightly larger than the circumference of the shell 101. Accordingly, the portion that forms a surface of the sound insulating member 200 may also called a sheet.

The sound insulating member 200 may be a first layer 210 forming an inner side that is brought in contact with the shell 101 and a second layer 220 being in contact with a surface of the first layer 210 and forming an outer side exposed to the outside.

The first layer 210 may be made of polyethylene (PE) having excellent sound absorption in the type of felt or non-woven fabric. The first layer 210 may have a predetermined length and may be in close contact with the outer side of the shell 101.

The first layer 210 may be made of a material being able to stand a high-temperature environment in addition to having sound absorption. Accordingly, the first layer prevents the compressor 10 from being changed in state or burned due to temperature while the compressor is manufactured, transported, and operated.

Obviously, the first layer 210 can be made of another sound-absorptive material that is safe even in a high-temperature environment other than polyethylene and may be formed in a sheet shape to be able to safely surround the cylindrical shell 101.

The second layer 220 may be made of an elastic rubber material. The second layer 220 may have the same size and shape as the first layer 210 and overlaps the first layer 210 such that the first layer 210 is not exposed to the outside with the sound insulating member 200 mounted.

The second layer 220 may be made of a rubber material and can additionally block vibration and noise generated from the shell 101. Further, the second layer can prevent damage due to external shock or scratch by being exposed outside with the sound insulating member 200 mounted.

Further, the second layer 220 is made of a rubber material, and is slightly extended by elastic deformation due to mounting of the sound insulating member 200 and is then mounted on the shell so that the sound insulating member 200 can be completely in close contact with the outer side of the shell 101.

An edge portion 201 for fixing the first layer 210 and the second layer 220 may be formed around the entire edge of the first layer 210 and the second layer 220. The edge portion 201 is defined by stitching with a thread or a wire, thereby being able to fixing the first layer 210 and the second layer 220. If necessary, an adhesive or an adhesive sheet may be provided between the first layer 210 and the second layer 220 to more firmly fix the first layer 210 and the second layer 220.

An additional fixing portion 202 connecting the first layer 210 and the second layer 220 may be further formed. The fixing portion 202 may be defined by the stitches of a thread or a wire defining the edge portion 201. The fixing portion 202 may be elongated in the longitudinal or lateral direction of the sound insulating member 200 and may be formed at a position corresponding to a second cut portion to be described below.

Accordingly, the first layer 210 and the second layer 220 can be fixed at the position where the second cut portion 250 is formed by the fixing portion 202 and separation of the first layer 210 and the second layer 220 around the second cut portion 250 where the edge portion 201 is not formed can be prevented.

The first layer 210 may be formed thicker than the second layer 220. For example, when the first layer 210 is 5 mm thick, the second layer 220 may be 1 mm thick. Accordingly, the first layer 210 can block sound and the second layer 220 can fix the sound insulating member 200 in a close contact state. Obviously, the second layer 220 can also block sound.

Fastening portions 231 and 232 that can fix the sound insulating member 200 mounted on the shell 101 may be provided at both ends of the sound insulating member 200. The fastening portion 231 and 232 can be fixed to each other with both ends connected to each other or overlapping each other and with the sound insulating member 200 surrounding the shell 101.

The fastening portions 231 and 232 may include a first fastening portion 231 disposed at an end of the sound insulating member 200 and a second fastening portion 232 disposed at the other end. The first fastening portion 231 and the second fastening portion 232 may be formed to have a male/female Velcro structure and are formed throughout the width of the sound insulating member 200, thereby being able to completely fasten both ends of the sound insulating member 200 to each other.

The fastening portions 231 and 232 may be formed in another bonding or coupling structure other than the Velcro structure, but it is preferable to have an attachable/detachable structure such as the Velcro structure for easy maintenance of the compressor 10.

First cut portions 240 and a second cut portion 250 may be formed at the sound insulating member 200. Both of the first cut portions 240 and the second cut portion 250 may be formed at the edge of the sound insulating member 200. Accordingly, the sound insulating member 200 can be formed in the shape by cutting the sound insulating member 200 with the first layer 210 and the second layer 220 overlapping each other, using a press in the process of machining the sound insulating member 200.

That is, the first cut portions 240 and the second cut portion 250 are not separately machined, but they can be simultaneously machined by one-time pressing and the entire edge of the sound insulating member 200 can be machined.

The first cut portions 240 allow the legs 50 to be exposed to the outside and can be cut inward from the outer side end of the sound insulating member 200. The first cut portions 240 may be formed opposite each other at both transverse ends of the sound insulating member 200.

A pair of legs 50 disposed at both sides can be exposed outside through the first cut portions. That is, the width W₁ of the first cut portions 240 may correspond to or may be slight larger than the distance L1 between the pair of legs 50 connected to the shell 101. Accordingly, all of four legs 50 on the shell 101 can be exposed outside by the pair of first cut portions 240.

The second cut portion 250 is provided to expose the terminal 108, the process pipe 106, and the discharge pipe 105 and may include a terminal portion 251 and a pipe portion 252.

The terminal portion 251 may be formed in a size and a shape that correspond to those of the terminal 108 and allows the terminal 108 and the bracket 109 to be exposed outside through the terminal portion 251 when the sound insulating member 200 is mounted. The terminal portion 251 may be spaced apart from an end of the sound insulating member 200 and is connected to the pipe portion 252.

The pipe portion 252 can allow the process pipe 106 and the discharge pipe 105 to be exposed and extends toward the terminal portion 251 from an outer side end of the sound insulating member 200 so that the terminal portion 251 can be formed by cutting.

In detail, the pipe portion 252 may be formed with a width W₂ corresponding to the distance L₂ from an outer side end of the process pipe 106 to an outer side end of the discharge pipe 106 to be able to accommodate both of the process pipe 106 and the discharge pipe 105. Accordingly, when the sound insulating member 200 is mounted, the process pipe 106 and the discharge pipe 105 both can be fitted in the pipe portion 252 and the process pipe 106 and the discharge pipe 105 both can be exposed by one-time work.

The pipe portion 252 is formed at a position corresponding to the process pipe 106 and the discharge pipe 105 and is formed to be able to connect the outer side end of the sound insulating member 200 and the terminal portion 251. Accordingly, the second cut portion 250 can be a single opening, and when the sound insulating member 200 is mounted, the terminal 108, the process pipe 106, and the discharge pipe 105 can be simultaneously exposed.

Hereinafter, a process of mounting the sound insulating member 200 in the compressor 10 having the above structure according to an embodiment of the present invention is described in detail with reference to the drawings.

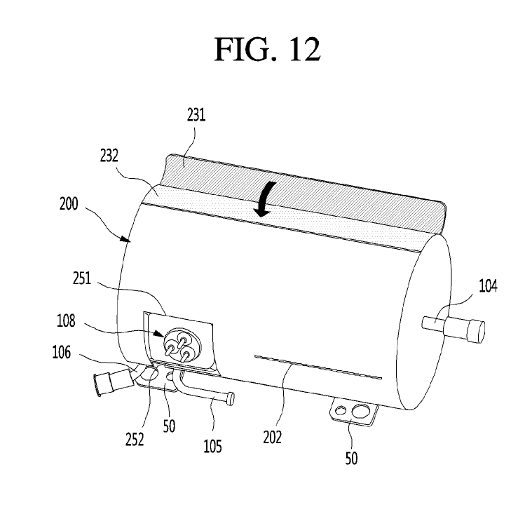

FIGS. 10 to 12 are views sequentially showing a process of mounting the sound insulating member.

As shown in the figures, the first shell cover 102 and the second shell cover 103 are mounted with the compressor body accommodated in the shell 101, thereby forming the external shape of the compressor 10. Then, the sound insulating member 200 is mounted to surround the cylindrical shell 101.

In order to mount the sound insulating member, as shown in FIG. 10, the sound insulating member 200 is first placed at a side of the compressor 10. In this state, the first layer 210 of the sound insulating member 200 is in contact with the outer side of the shell 101 and the second layer 220 can be exposed to the outside.

The sound insulating member 200 can be mounted in the process of manufacturing the compressor 10 or before a refrigerator or an air condition is assembled, and if necessary, the sound insulating member 200 may be mounted with the compressor 10 is mounted in a refrigerator or the outdoor unit of an air conditioner. This is because the sound insulating member 200 is made a flexible material in a sheet shape, so the sound insulating member 200 can be placed in or removed from a space between the floor of an installation space and the shell 101 spaced by the legs 50.

The sound insulating member 200 may be disposed such that the first cut portions 240 are positioned at the legs 50. As shown in FIG. 11, the sound insulating member 200 can be aligned in position after disposed such that the legs 50 are exposed through the first cut portions 240. Further, since the legs 50 protrude through the first cut portions 240, the first cut portions 240 are retained by the four legs 50, so the sound insulating member 200 can be fixed at the exact position. In this state, as the shell 101 is covered with the sound insulating member 200, the terminal 108, the process pipe 106, and the discharge pipe 105 can be naturally exposed outside.

The entire shell 101 can be covered with the sound insulating member 200 by holding both ends of the sound insulating member 200 and wrapping the sound insulating member 200 around the shell 101 with the legs 50 exposed through the first cut portions 240.

Further, as shown in FIG. 12, while the shell 101 is covered with the sound insulating member 200, the terminal 108 can be exposed through the terminal portion 251, and the process pipe 106 and the discharge pipe 105 can be naturally exposed through the pipe portion 252. In this process, a user does not need to intentionally expose the terminal 108, the process pipe 106, and the discharge pipe 105, and the terminal 108, the process pipe 106, and the discharge pipe 105 can pass through the second cut portion 250 while the sound insulating member 200 is wound.

When the shell 101 is completely covered with the sound insulating member 200, both ends of the sound insulating member 200 are connected to each other or overlap each other, and mounting the sound insulating member 200 can be finished by fixing both ends of the sound insulating member 200 with the first fastening portion 231 and the second fastening portion 232 overlapping each other.

The sound insulating member 200 can be extended by elastic deformation while the first fastening portion 231 and the second fastening portion 232 are fastened. In this state, when the first fastening portion 231 and the second fastening portion 232 are fastened, the second layer 220 can press the outer side of the shell 101, so the first layer 210 can be completely in close contact with the outer side of the shell 101 and the sound insulting effect of the sound insulating member 200 can be further increased.

Meanwhile, the sound insulating member according to the embodiment of the present invention may be implemented in other various embodiments other than the embodiment described above.

A sound insulating member according to another embodiment of the present invention is described hereafter in detail with reference to the drawings.

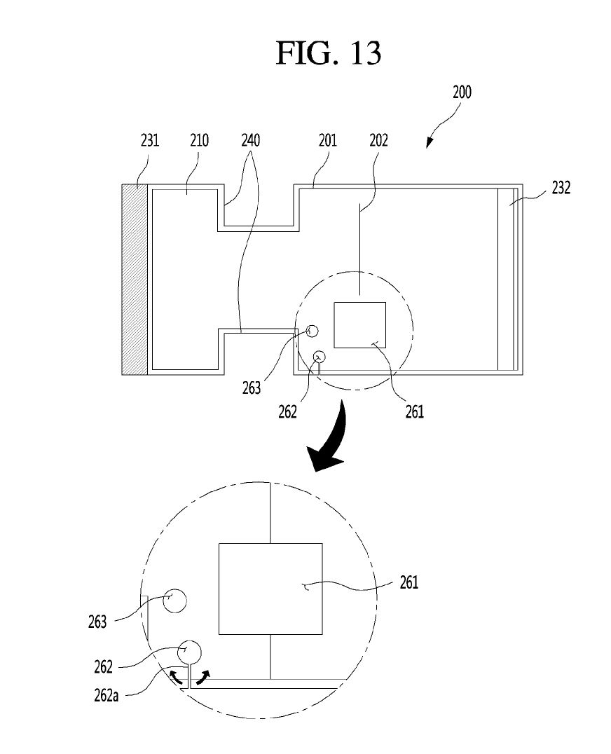

FIG. 13 is a plan view of a sound insulating member according to another embodiment of the present invention.

A sound insulating member 200 according to another embodiment of the present invention has the same configuration as the sound insulating member of the previous embodiment except for the second cut portion 250, so the same components are given the same reference numbers and are not described in detail.

As shown in the figure, the sound insulating member 200 according to another embodiment of the present invention may be composed of two layers of a first layer 210 and a second layer 220, and a first fastening portion 231 and a second fastening portion 232 may be formed in a male/female Velcro shape at both transverse ends of the sound insulating member 200.

A pair of first cut portions 240 may be formed at a position corresponding to the legs 50 when the sound insulating member 200 is mounted.

A terminal hole 261 may be formed at a position corresponding to the terminal 108, a first pipe hole 262 may be formed at a position corresponding to the process pipe 106, and a second pipe hole 263 may be formed at a position corresponding to the discharge pipe 105 when the sound insulating member 200 is mounted.

The terminal hole 261, the first pipe hole 262, and the second pipe hole 263 are formed in shapes corresponding to the cross-sections of the terminal 108, the process pipe 106, and the discharge pipe 105, respectively. Accordingly, with the sound insulating member 200 mounted, the terminal 108, the process pipe 106, and the discharge pipe 105 can be exposed to the outside through the sound insulating member 200.

The first pipe hole 262 is formed close to the edge of the sound insulating member 200, as compared with the second pipe hole 263, a third cut portion 262a is formed at the first pipe hole 262.

The third cut portion 262a is formed for easy mounting of the sound insulating member 200 and may connect the outer side end of the first pipe hole 262 and an adjacent edge of the sound insulating member 200. Accordingly, the bending process pipe 106 can be easily inserted into the first pipe hole 262 when the sound insulating member 200 is mounted.

Accordingly, when the sound insulating member 200 is mounted, the discharge pipe 105 is fitted first into the second pipe hole 263 to be exposed and then the shell 101 can be covered with the sound insulating member 200. In this process, the process pipe 106 may be disposed through the first pipe hole 262 through the third cut portion 262a.

Obviously, if necessary, a structure like the third cut portion 262a may be applied to the second pipe hole 263 so that the bending discharge pipe 105 can be easily exposed through the second pipe hole 263.

### INDUSTRIAL APPLICABILITY

According to the compressor and a sound insulating member for a compressor of an embodiment of the present invention, a compressor can be implemented in a compact size, the manufacturing cost can be reduced, and productivity can be improved, so it is possible to consider that industrial applicability is high.

1. A compressor comprising:
a cylindrical shell;
a first shell cover and a second shell cover covering both open ends of the shell;
a plurality of legs extending from the outer side of the shell to be fixed in an installation space;
a suction pipe connected to the shell cover to suction a refrigerant;
a terminal disposed on a circumferential surface of the shell and connected to a power supply terminal;
a process pipe connected to the circumferential surface of the shell to supplement the refrigerant;
a discharge pipe connected to the circumferential surface of the shell to discharge compressed refrigerant; and
a sound insulating member formed in a sheet shape to be in close contact with the circumferential surface of the shell, blocking vibration noise of the shell, and having fastening portions formed at both ends to be fastened to each other.

2. The compressor of claim 1, wherein the sound insulating member includes:
a first layer formed in the type of felt of non-woven fabric and being in close contact with the outer side of the shell to absorb vibration noise; and
a second layer forming a surface exposed outside by being bonded to the first layer and made of an elastic member to press the outer side of the shell.

3. The compressor of claim 1, wherein a side of the sound insulating member that corresponds to the positions of the legs, the terminal, the process pipe, and the discharge pipe is open.

4. The compressor of claim 3, wherein the terminal, the process pipe, and the discharge pipe are disposed close to the second shell cover at the center of the shell.

5. The compressor of claim 4, wherein the terminal, the process pipe, and the discharge pipe are positioned at different heights.

6. The compressor of claim 4, wherein the terminal, the process pipe, and the discharge pipe are positioned within 90° around the axial center of the shell.

7. A sound insulating member for a compressor, the sound insulating member comprising:
a first layer formed in the type of felt of non-woven fabric and being in close contact with the outer side of the shell, which forms the circumference of a cylindrical compressor, to absorb vibration noise; and
a second layer forming a surface exposed outside by being bonded to the first layer and made of an elastic member to press the outer side of the shell,
wherein fastening portions fastened to each other with the second layer extended are formed at both ends of the second layer.

8. The sound insulating member of claim 7, wherein the first layer is made of an inflammable polyethylene material.

9. The sound insulating member of claim 7, wherein an edge portion is defined by stitching a thread or a wire around the first layer and the second layer to combine the first layer and the second layer.

10. The sound insulating member of claim 7, wherein the fastening portions include a first fastening portion and a second fastening portion formed in a male/female Velcro structure respectively at both ends of the second layer.

11. A sound insulating member for a compressor, comprising:
a rectangular sheet made of a sound absorbing material and having a width corresponding to a cylindrical compressor shell and a length corresponding to the circumference of the shell;
fastening portions formed at both longitudinal ends of the sheet and fastened to each other while surrounding the shell;
first cut portions formed at both width-directional ends of the sheet and exposing legs for fixing the shell; and
an opening formed at a position corresponding to a terminal, a process pipe, and a discharge pipe connected to the shell to expose the terminal, the process pipe, and the discharge pipe.

12. The sound insulating member of claim 11, wherein the opening is a second cut portion formed at a width-directional end of the sheet close to the first cut portion to pass the terminal, the process pipe, and the discharge pipe.

13. The sound insulating member of claim 12, wherein the second cut portion includes:
a terminal portion formed to be open in a shape corresponding to the terminal; and
a pipe portion cut at a width-directional end of the sheet to connect the terminal portion and passing both of the process pipe and the discharge pipe.

14. The sound insulating member of claim 13, wherein the width of the pipe portion is larger than the distance between outer side ends of the process pipe and the discharge pipe.

15. The sound insulating member of claim 11, wherein the opening includes:
a terminal hole formed at a position corresponding to the terminal to pass the terminal;
a first pipe hole formed at a position corresponding to the joint between the process pipe and the shell to pass the process pipe; and
a second pipe hole formed at a position corresponding to the joint between the discharge pipe and the shell to pass the discharge pipe.

16. The sound insulating member of claim 15, wherein a third cut portion cut from a width-directional end of the sheet to at least any one of the first pipe hole or the second pipe hole is further formed at the sheet.
